(19) United States
(12) Patent Application Publication
(10) Pub. No.: US 2025/0310392 A1
(43) Pub. Date: Oct. 2, 2025

(54) MODEL TO VERIFY QUALITY OF A DATA STREAM

(71) Applicant: Capital One Services, LLC, McLean, VA (US)

(72) Inventor: Ragini BHUYAN, Washington, DC (US)

(21) Appl. No.: 18/623,735

(22) Filed: Apr. 1, 2024

(51) Int. Cl. H04L 65/80; H04L 65/1059

(52) U.S. Cl. CPC H04L 65/80; H04L 65/1059

(57) ABSTRACT

In some implementations, a user device may transmit, to a quality checker, an identifier of the data stream. The data stream may include a sequence of characters. The user device may receive, from the quality checker, a report indicating whether the data stream is valid. The user device may detect an interaction based on the report. The user device may transmit, to the quality checker, a command to approve or reject the data stream based on the interaction.

### BACKGROUND

Some computerized systems accept, as input, and/or product, as output, data streams rather than data structures. For example, a computerized system may accept a sequence of characters encoded according to American Standard Code for Information Interchange (ASCII) standards, Unicode standards, or other character encoding standards.

### SUMMARY

Some implementations described herein relate to a system for verifying quality of a data stream. The system may include one or more memories and one or more processors communicatively coupled to the one or more memories. The one or more processors may be configured to receive the data stream, wherein the data stream comprises characters encoded according to American Standard Code for Information Interchange (ASCII) standards. The one or more processors may be configured to provide the data stream to a machine learning model in order to receive an indication of whether the data stream is valid, wherein the machine learning model is configured to determine validity based on position and content of the characters. The one or more processors may be configured to selectively transmit the data stream to a third-party system based on the indication of whether the data stream is valid.

Some implementations described herein relate to a method of verifying quality of a data stream. The method may include transmitting, to a quality checker and from a user device, an identifier of the data stream, the data stream comprising a sequence of characters. The method may include receiving, from the quality checker and at the user device, a report indicating whether the data stream is valid. The method may include detecting, by the user device, an interaction based on the report. The method may include transmitting, to the quality checker and from the user device, a command to approve or reject the data stream based on the interaction.

Some implementations described herein relate to a non-transitory computer-readable medium that stores a set of instructions for verifying quality of a data stream. The set of instructions, when executed by one or more processors of a device, may cause the device to receive the data stream, wherein the data stream comprises a sequence of characters. The set of instructions, when executed by one or more processors of the device, may cause the device to provide the data stream to a machine learning model in order to receive an indication of at least one error in the data stream, wherein the machine learning model is configured to determine validity based on position and content of the characters. The set of instructions, when executed by one or more processors of the device, may cause the device to transmit a report, to a user device, including the indication of the at least one error. The set of instructions, when executed by one or more processors of the device, may cause the device to receive an updated data stream in response to the report. The set of instructions, when executed by one or more processors of the device, may cause the device to transmit the updated data stream to a third-party system.

### BRIEF DESCRIPTION OF THE DRAWINGS

FIGS. 1A-1E are diagrams of an example implementation relating to using a model to verify quality of a data stream, in accordance with some embodiments of the present disclosure.

FIGS. 2A-2B are diagrams of example character sequences that form portions of data streams, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIGS. 5-6 are flowcharts of example processes relating to verifying quality of a data stream, in accordance with some embodiments of the present disclosure.

### DETAILED DESCRIPTION

The following detailed description of example implementations refers to the accompanying drawings. The same reference numbers in different drawings may identify the same or similar elements.

Some computerized systems accept, as input, and/or produce, as output, data streams rather than data structures. For example, a computerized system may accept a sequence of characters encoded according to ASCII standards, Unicode standards, or other character encoding standards. Because data streams are unstructured, typical data quality rules (e.g., using regular expressions or “regexes”) cost more power and processing resources to apply. Additionally, because data streams are unstructured, a whole data stream is loaded into memory to apply typical data quality rules, which increases memory overhead.

Machine learning models that assess data quality generally convert structured data into vectors in order to score or otherwise measure data quality of the structured data. However, data streams are unstructured, so machine learning models trained on structured data cannot be applied to data streams.

Some implementations described herein enable a machine learning model to use position and content of characters in a data stream to determine validity of the data stream. The machine learning model uses less power and fewer processing resources than applying typical data quality rules (e.g., regexes) to the data stream. Additionally, the machine learning model may parse the data stream in sequence in order to reduce memory overhead as compared with applying typical data quality rules. Furthermore, the machine learning model is trained to use position and content of characters rather than data structure in order to assess validity. As a result, the machine learning model may be applied to the data stream without error.

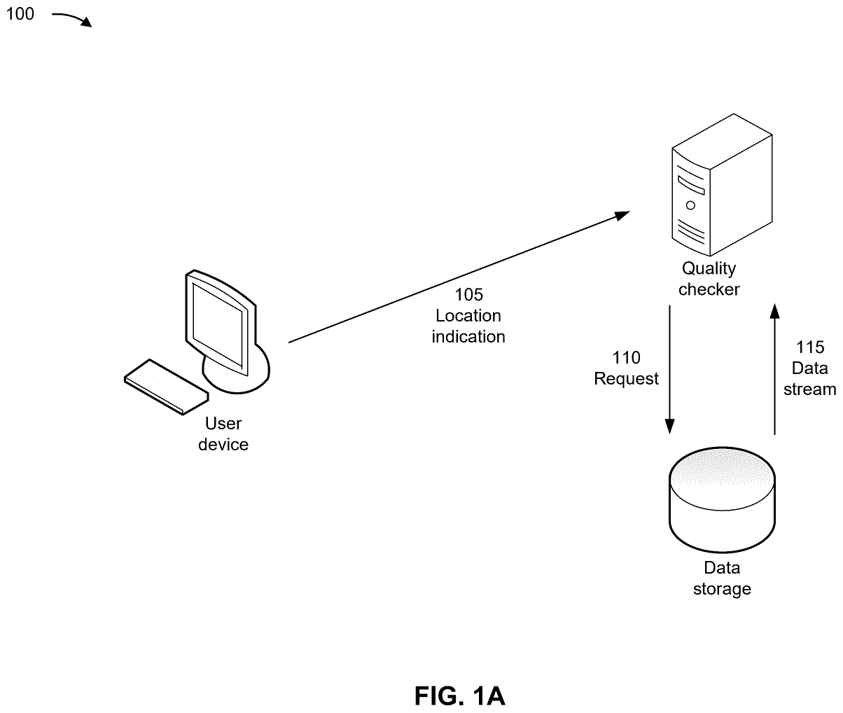

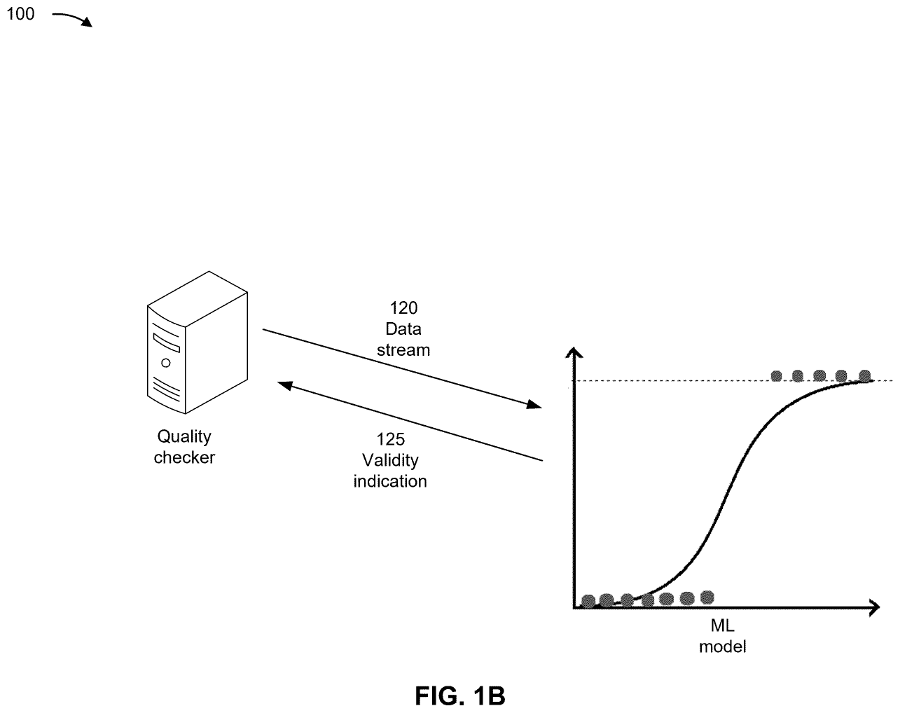

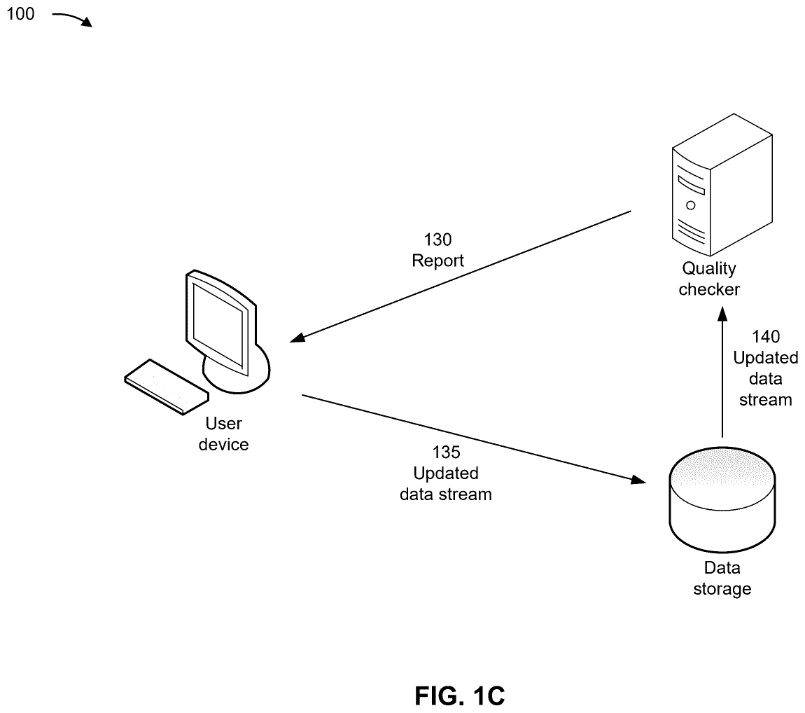

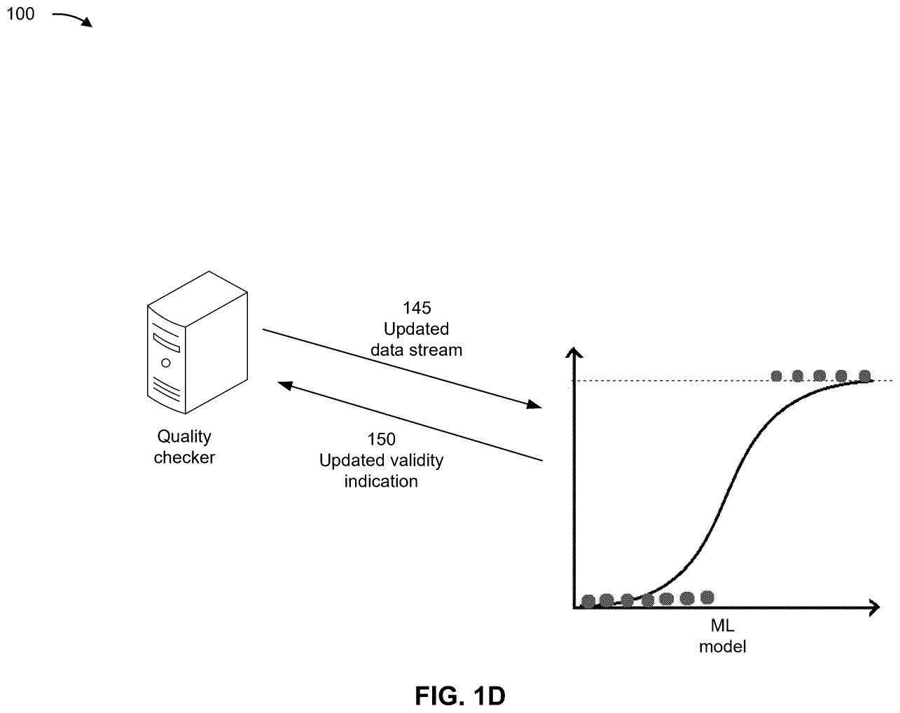

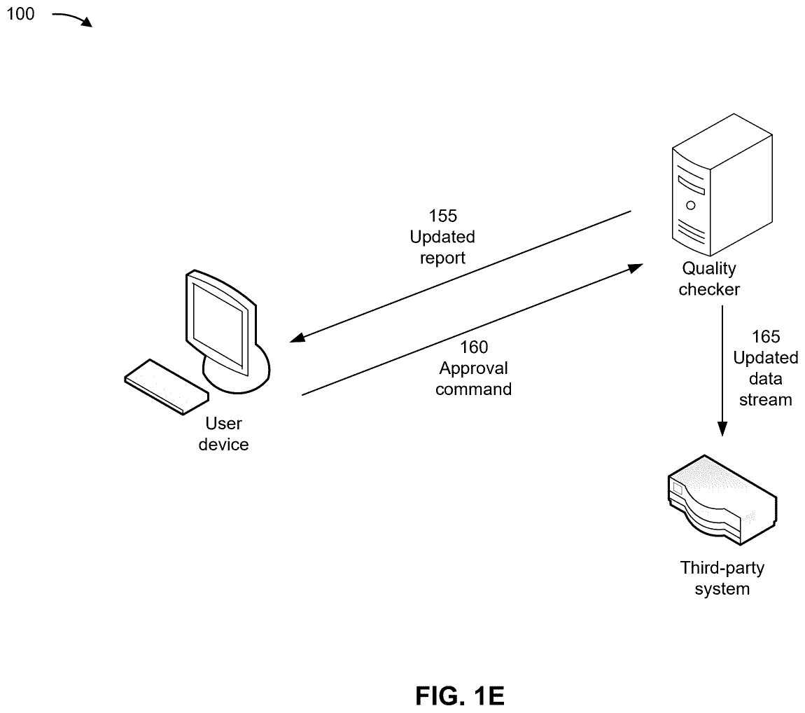

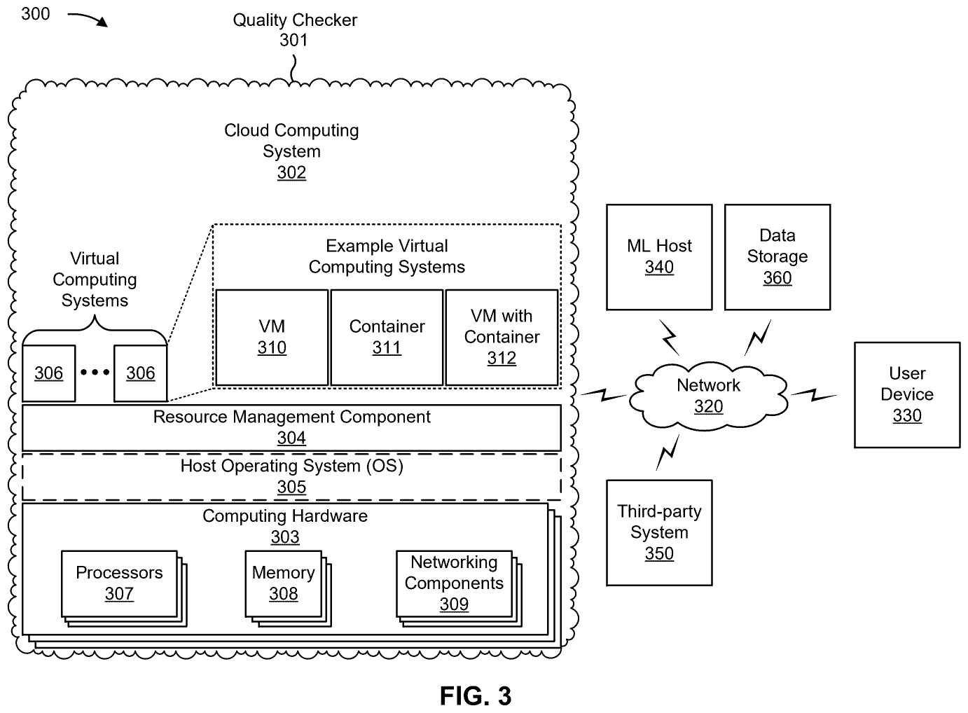

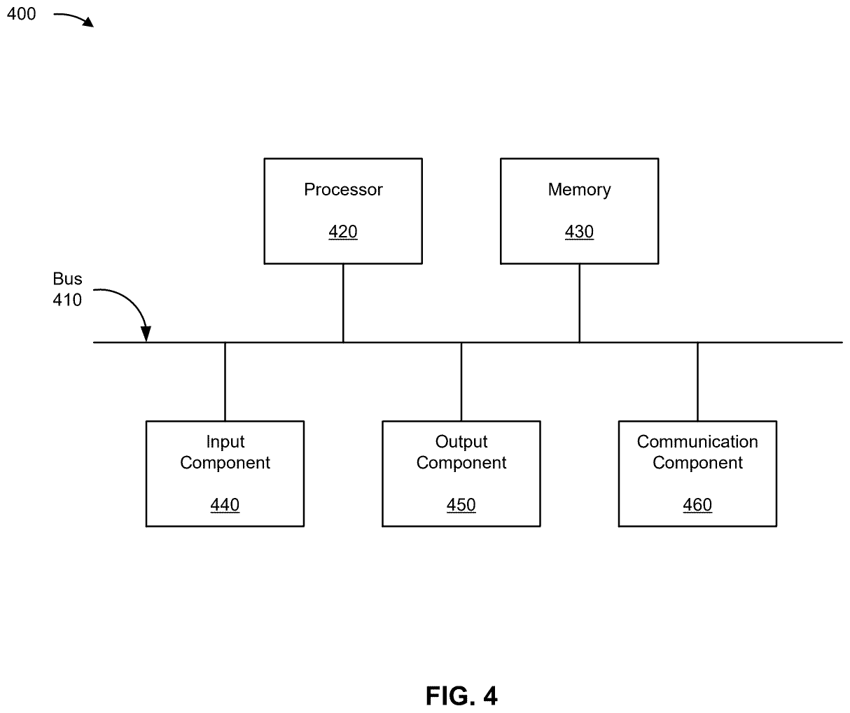

FIGS. 1A-1E are diagrams of an example 100 associated with using a model to verify quality of a data stream. As shown in FIGS. 1A-1E, example 100 includes a user device, a quality checker, a data storage, a machine learning (ML) model (e.g., provided by an ML host), and a third-party system. These devices are described in more detail in connection with FIGS. 3 and 4.

As shown in FIG. 1A and by reference number 105, the user device may transmit, and the quality checker may receive, an indication of a location associated with the data stream. For example, the indication may include a filepath associated with the data stream. The filepath may include a filename and may optionally indicate a directory (or a sequence of directories) in which the data stream is stored. In some implementations, the filepath may additionally indicate that the data stream is stored on the data storage (e.g., via an Internet protocol (IP) address, a medium access control (MAC) address, a machine name, and/or another type of alphanumeric identifier associated with the data storage). Although the example 100 is described in connection with the user device transmitting a location indication, other examples may include user device may transmit a different type of identifier of the data stream. For example, the identifier may include a name of the data stream.

The user device may transmit the identifier of the data stream with a request (e.g., a hypertext transfer protocol (HTTP) request, a file transfer protocol (FTP) request, and/or an application programming interface (API) call) to assess the data stream. For example, the identifier may be included in a header of the request and/or as an argument of the request.

In some implementations, a user of the user device may provide input (e.g., using an input component of the user device) that triggers the user device to transmit the identifier. For example, a web browser (and/or another application executed by the user device) may navigate to a website controlled by (or at least associated with) the quality checker and may output a user interface (UI) (e.g., using an output component of the user device) to the user. Therefore, the user may interact with the UI to provide the input that triggers the user device to transmit the identifier. In another example, the user may provide the input using a command line, a bash shell, or another type of text interface. Additionally, or alternatively, the user device may transmit the identifier automatically. For example, the user device may transmit the identifier periodically (e.g., according to a schedule, whether a default schedule or a schedule configured by the user). In another example, the user device may transmit the command in response to a trigger event.

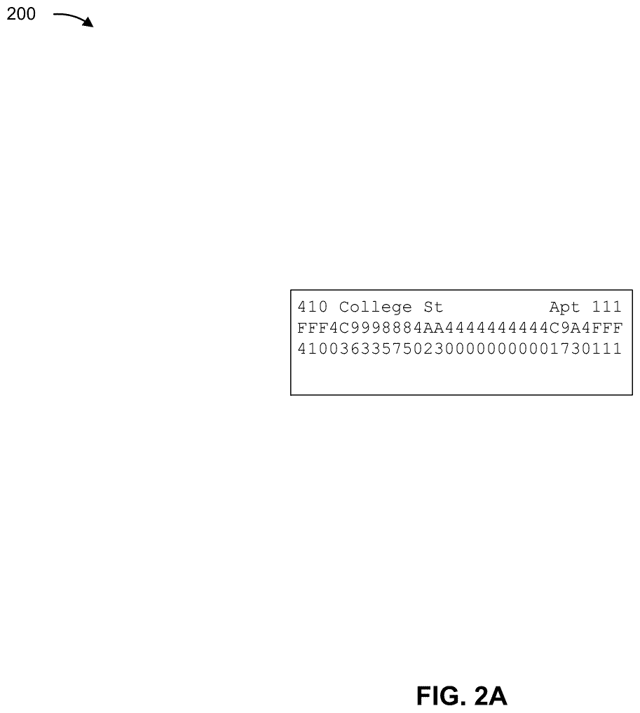

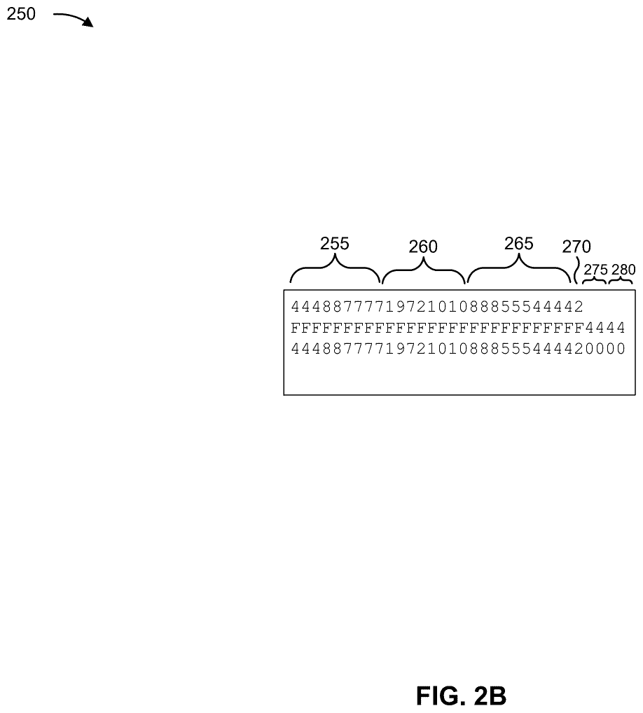

The data stream may be a sequence of characters. For example, the data stream may include characters encoded according to ASCII standards or Unicode standards, among other examples. Additionally, or alternatively, the data stream may be a sequence of hexadecimals encoding the sequence of characters (e.g., according to ASCII standards or Unicode standards, among other examples). Therefore, the data stream is unstructured. As used herein, “unstructured” may refer to text-based data. Unstructured data is distinct from “structured data,” which may refer to a set of data that is organized according to a data model (e.g., in an extensible markup language (XML) file; a JavaScript® object notation (JSON) file; a comma-separated values (CSV) file, a tab-separated values (TSV) file, or another type of delimiter-separate values (DSV) file; and/or a spreadsheet file or another type of tabular file; among other examples). An example data stream is described in connection with FIG. 2A.

As shown by reference number 110, the quality checker may transmit, and the data storage may receive, a request for the data stream. The request may include an HTTP request, an FTP request, and/or an API call. The request may include (at least a portion of) the identifier of the data stream in a header and/or as an argument. Accordingly, the request may be based on the identifier from the user device. Additionally, or alternatively, the quality checker may determine the data storage (e.g., determine an IP address, a MAC address, a machine name, and/or another type of alphanumeric identifier associated with data storage) from the identifier. Therefore, the request may be transmitted to the data storage based on the identifier from the user device.

As shown by reference number 115, the data storage may transmit, and the quality checker may receive, the data stream. For example, the data storage may transmit, and the quality checker may receive, the data stream in response to the request from the quality checker (e.g., as described in connection with reference number 110). The data storage may transmit the data stream in an HTTP response, in an FTP response, and/or as a return from a call to an API function associated with the data storage.

Although the example 100 is described in connection with the quality checker receiving the data stream from the data storage, other examples may include the quality checker receiving the data stream directly from the user device (in addition to, or in lieu of, the identifier of the data stream). For example, the data stream may be stored in a memory of the user device (e.g., encoded in a file or another type of resource). Accordingly, the user device may transmit, and the quality checker may receive, the data stream. The user device may transmit the data stream with a request (e.g., an HTTP request, an FTP request, and/or an API call) to assess the data stream. Alternatively, the user device may transmit the data stream separately from the request. For example, the quality checker may prompt the user device for the data stream in response to the request, and the user device may transmit the data stream in response to the prompt.

As shown in FIG. 1B and by reference number 120, the quality checker may provide the data stream to the ML model. For example, the quality checker may transmit, and the ML host may receive, a request including the data stream. In some implementations, the quality checker may provide the data stream to the ML model in response to receiving the data stream from the data storage. Additionally, or alternatively, the quality checker may provide the data stream to the ML model based on the request to assess the data stream from the user device.

The ML model may be trained (e.g., by the ML host and/or a device at least partially separate from the ML host) using labeled data streams (e.g., for supervised learning). In some implementations, the ML model may additionally be trained using a set of rules associated with the third-party system. Additionally, or alternatively, the ML model may be trained using unlabeled data streams (e.g., for deep learning). The ML model may be configured to determine whether the data stream is valid. For example, the ML model may be a binary classification model. The ML model may be configured to compare positions and content of characters in the data stream with positions and content of characters in labeled data streams (e.g., in order to output an indication of validity for the data stream). Additionally, or alternatively, the ML model may be configured to cluster the data stream with similar labeled data streams (e.g., based on position and content of characters in the data stream); therefore, an indication of validity for the data stream may be determined based on which cluster the data stream is classified into.

In some implementations, the ML model may be further configured to determine errors (if any) in the data stream. The ML model may be configured to compare positions and content of characters in the data stream with positions and content of characters in labeled data streams (e.g., in order to output an indication of any errors, or an indication of no errors, in the data stream). Additionally, or alternatively, the ML model may be configured to cluster the data stream with similar labeled data streams (e.g., based on position and content of characters in the data stream); therefore, an indication of errors (if any) in the data stream may be determined based on which cluster the data stream is classified into.

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., labeled or unlabeled data streams). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the quality checker, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm. An example data stream, labeled with position and content of characters used to determine validity, is described in connection with FIG. 2B.

As shown by reference number 125, the quality checker may receive the indication of whether the data stream is valid (and/or the indication of any errors in the data stream) from the ML model (e.g., from the ML host). For example, the quality checker may receive the indication of whether the data stream is valid (and/or the indication of any errors in the data stream) in response to the request from the quality checker (e.g., as described in connection with reference number 120). The indication of whether the data stream is valid may include a binary indicator (e.g., a Boolean value set to ‘TRUE’ or ‘FALSE’ and/or a bit set to ‘1’ or ‘0’). The indication of any errors in the data stream may include one or more error codes (e.g., set to indicate a particular error from a set of possible errors or set to a null value to indicate no errors). Additionally, or alternatively, the indication of any errors in the data stream may include one or more strings (e.g., selected from a set of error descriptors to represent a particular error or set to a default value such as “no error” to indicate no errors).

As shown in FIG. 1C and by reference number 130, the quality checker may transmit, and the user device may receive, a report. The report may include the indication of whether the data stream is valid and/or the indication of any errors in the data stream. The report may be a file, such as a portable document format (pdf) file, among other examples. Additionally, or alternatively, the report may be included in a UI that is output by the user device (e.g., via an output component of the user device). Accordingly, the quality checker may transmit instructions for the UI.

The user device may detect an interaction based on the report. For example, the user may interact with the report via an input component of the user device. Accordingly, the interaction may a click of a mouse, a key press on a keyboard, a tap on a touchscreen, or a voice command provided to a microphone, among other examples. Based on the interaction, the user device may transmit a command to approve or reject the data stream. For example, after reviewing the report, the user may interact with a button (or another UI element) associated with approval of the data stream or may provide a text command associated with approval of the data stream. Therefore, the user device may transmit a command to approve the data stream in response to the interaction. In another example, after reviewing the report, the user may interact with a button (or another UI element) associated with rejection of the data stream or may provide a text command associated with rejection of the data stream. Therefore, the user device may transmit a command to reject the data stream in response to the interaction.

Although the example 100 is described in connection with the user device determining whether to approve or reject the data stream, other examples may include the quality checker automatically determining whether to approve or reject the data stream. For example, the quality checker may selectively transmit the data stream to the third-party system based on the indication of whether the data stream is valid. In some implementations, the quality checker may transmit the data stream to the third-party system (e.g., similarly as described in connection with reference number 165), based on the indication indicating that the data stream is valid, and may refrain from transmitting the data stream to the third-party system, based on the indication indicating that the data stream is invalid.

When the data stream is rejected (either by the user of the user device or automatically by the quality checker), the data stream may be updated. For example, the user device may generate an updated data stream based on the report. In some implementations, the user may provide input that triggers the user device to generate the updated data stream. The input may indicate a change to the data stream used to generate the updated data stream. Additionally, or alternatively, the quality checker and/or the user device may generate a recommended change to the data stream (e.g., based on the indication of any errors in the data stream). Therefore, the user may provide input that triggers the user device to accept the recommended change and generate the updated data stream using the recommended change.

As shown by reference number 135, the user device may transmit, and the data storage may receive, the updated data stream. For example, the user device may transmit the updated data stream with an instruction to overwrite the data stream with the updated data stream.

Although the example 100 is described in connection with the user device transmitting a full copy of the updated data stream, other examples may include the user device transmitting an indication of a change to make to the data stream (e.g., such that the data storage modifies the data stream to generate the updated data stream).

As shown by reference number 140, the data storage may transmit, and the quality checker may receive, the updated data stream. In some implementations, the data storage may transmit, and the quality checker may receive, the updated data stream in response to the report. For example, the user device may trigger the data storage to transmit the updated data stream to the quality checker in response to the report. The user device may include the trigger in a same message that includes the updated data stream, as described in connection with reference number 135, or in a separate message. Additionally, or alternatively, the quality checker may transmit, and the data storage may receive, a request for the updated data stream. For example, the user device may trigger the quality checker to transmit the request (e.g., in a same message rejecting the data stream, as described above, or in a request to assess the updated data stream). Therefore, the data storage may transmit, and the quality checker may receive, the updated data stream in response to the request from the quality checker.

Although the example 100 is described in connection with the quality checker receiving the updated data stream from the data storage, other examples may include the quality checker receiving the updated data stream directly from the user device (in addition to, or in lieu of, an identifier of the updated data stream). For example, the updated data stream may be stored in a memory of the user device (e.g., encoded in a file or another type of resource). Accordingly, the user device may transmit, and the quality checker may receive, the updated data stream. The user device may transmit the updated data stream with a request (e.g., an HTTP request, an FTP request, and/or an API call) to assess the data stream. Alternatively, the user device may transmit the updated data stream separately from the request. For example, the quality checker may prompt the user device for the updated data stream in response to the request, and the user device may transmit the data stream in response to the prompt.

As shown in FIG. 1D and by reference number 145, the quality checker may provide the updated data stream to the ML model. For example, the quality checker may transmit, and the ML host may receive, a request including the updated data stream. In some implementations, the quality checker may provide the updated data stream to the ML model in response to receiving the data stream from the updated data storage. Additionally, or alternatively, the quality checker may provide the updated data stream to the ML model based on the request to assess the updated data stream from the user device.

As shown by reference number 150, the quality checker may receive an indication of whether the updated data stream is valid (and/or an indication of any errors in the updated data stream) from the ML model (e.g., from the ML host). For example, the quality checker may receive the indication of whether the updated data stream is valid (and/or the indication of any errors in the updated data stream) in response to the request from the quality checker (e.g., as described in connection with reference number 145).

As shown in FIG. 1E and by reference number 155, the quality checker may transmit, and the user device may receive, an updated report. The updated report may include the indication of whether the updated data stream is valid and/or the indication of any errors in the updated data stream. The user device may detect an interaction based on the updated report. Based on the interaction, the user device may transmit a command to approve or reject the updated data stream. For example, after reviewing the report, the user may interact with a button (or another UI element) associated with approval of the updated data stream or may provide a text command associated with approval of the updated data stream. Therefore, the user device may transmit a command to approve the updated data stream in response to the interaction. In another example, after reviewing the report, the user may interact with a button (or another UI element) associated with rejection of the updated data stream or may provide a text command associated with rejection of the updated data stream. Therefore, the user device may transmit a command to reject the updated data stream in response to the interaction.

As shown by reference number 160, the user device may transmit, and the quality checker may receive, a command to approve the updated data stream. Therefore, as shown by reference number 165, the quality checker may transmit, and the third-party system may receive, the updated data stream. For example, the quality checker may transmit, and the third-party system may receive, the updated data stream in response to the command. The quality checker may transmit an HTTP message including the updated data stream, transmit an FTP message including the updated data stream, and/or perform an API call with the updated data stream as an argument. The API call may be performed using an endpoint of an API function provisioned by (or at least associated with) the third-party system. In some implementations, the third-party system may associated with a credit bureau (e.g., an Experian® system, an Equifax® system, or a Transunion® system, among other examples). Therefore, the data stream may be an update intended for the credit bureau.

In some implementations, the quality checker may transmit, and the user device may receive, a confirmation that the updated data stream was transmitted to the third-party system. Although FIG. 1E depicts approval of the updated data stream, the user device may alternatively transmit, and the quality checker may alternatively receive, a command to reject the updated data stream. Therefore, operations described in connection with FIGS. 1C-1E may be repeated iteratively until a valid version of the data stream results.

Although the example 100 is described in connection with the user device determining whether to approve or reject the updated data stream, other examples may include the quality checker automatically determining whether to approve or reject the updated data stream. For example, the quality checker may selectively transmit the updated data stream to the third-party system based on the indication of whether the data stream is valid.

By using techniques as described in connection with FIGS. 1A-1E, the ML model may use position and content of characters in the data stream to determine validity of the data stream. As a result, the ML model may be applied to the data stream without error. The ML model also uses less power and fewer processing resources than applying regexes to the data stream. Additionally, the ML model may parse the data stream in sequence in order to reduce memory overhead as compared with applying regexes.

As indicated above, FIGS. 1A-1E are provided as an example. Other examples may differ from what is described with regard to FIGS. 1A-1E.

FIGS. 2A and 2B are diagrams of example character sequences 200 and 250, respectively, that form portions of data streams. The example character sequences 200 and 250 may be validated by a quality checker (e.g., as described in connection with FIGS. 1A-1E). This device is described in more detail in connection with FIGS. 3 and 4.

As shown in FIG. 2A, the example character sequence 200 is “410 College St Apt 111” including spaces. The example character sequence 200 is encoded according to ASCII standards with a sequence of hexadecimals. In FIG. 2A, for example, hexadecimal “F4” represents the character “4”; hexadecimal “C3” represents the character “C”; and hexadecimal “40” represents a space; among other examples.

As shown in FIG. 2B, the example character sequence 250 is “4448877771972101088855544442” including spaces. Similar to the example character sequence 200, the example character sequence 250 is encoded according to ASCII standards with a sequence of hexadecimals. In FIG. 2B, for example, hexadecimal “F4” represents the character “4”; hexadecimal “F8” represents the character “8”; and hexadecimal “40” represents a space; among other examples.

As further shown in FIG. 2B, the example character sequence 250 uses position and content of characters to form a valid data stream. For example, in FIG. 2B, positions 255 of the example character sequence 250 encode a social security number (SSN). The positions 255 should therefore include nine numerical characters with no spaces, dashes, or other delimiters. Furthermore, in FIG. 2B, positions 260 of the example character sequence 250 encode a date of birth (DOB). The positions 255 should therefore include four numerical characters representing a year, followed by two numerical characters representing a month, followed by two numerical characters representing a day, with no spaces, dashes, or other delimiters. In FIG. 2B, positions 265 of the example character sequence 250 encode a telephone number. The positions 265 should therefore include ten numerical characters with no spaces, dashes, or other delimiters. FIG. 2B further shows an extra character in position 270 (set to hexadecimal “F2” to represent the numerical character “2”), two buffer characters in positions 275 (each set to hexadecimal “40” to represent a space), and two control characters in positions 280 (each set to hexadecimal “40” to represent a space).

As indicated above, FIGS. 2A-2B are provided as examples. Other examples may differ from what is described with regard to FIGS. 2A-2B. For example, the example character sequences 200 and 250 may represent full data streams or portions of larger data streams. Additionally, or alternatively, other examples may use additional or no extra characters; additional, fewer, or no buffer characters; and/or additional, fewer, or no control characters. Although described in connection with ASCII standards, other examples may use different encoding standards, such as Unicode standards.

FIG. 3 is a diagram of an example environment 300 in which systems and/or methods described herein may be implemented. As shown in FIG. 3, environment 300 may include a quality checker 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an ML host 340, a third-party system 350, and/or a data storage 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303.

As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the quality checker 301 may include one or more elements 303-312 of the cloud computing system 302, may execute within the cloud computing system 302, and/or may be hosted within the cloud computing system 302, in some implementations, the quality checker 301 may not be cloud-based (e.g., may be implemented outside of a cloud computing system) or may be partially cloud-based. For example, the quality checker 301 may include one or more devices that are not part of the cloud computing system 302, such as device 400 of FIG. 4, which may include a standalone server or another type of computing device. The quality checker 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with data streams, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The ML host 340 may include one or more devices capable of receiving, generating, storing, processing, and/or providing information associated with machine learning models, as described elsewhere herein. The ML host 340 may include a communication device and/or a computing device. For example, the ML host 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 340 may communicate with one or more other devices of environment 300, as described elsewhere herein.

The third-party system 350 may include one or more devices capable of receiving, generating, storing, processing, and/or providing information associated with machine learning models, as described elsewhere herein. The third-party system 350 may include a communication device and/or a computing device. For example, the third-party system 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The third-party system 350 may be controlled by (or at least associated with) a credit bureau (e.g., Experian, Equifax, or Transunion, among other examples). The third-party system 350 may communicate with one or more other devices of environment 300, as described elsewhere herein.

The data storage 360 may include one or more devices capable of receiving, generating, storing, processing, and/or providing information associated with data streams, as described elsewhere herein. The data storage 360 may include a communication device and/or a computing device. For example, the data storage 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data storage 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with using a model to verify quality of a data stream. The device 400 may correspond to a user device 330, an ML host 340, a third-party system 350, and/or a data storage 360. In some implementations, a user device 330, an ML host 340, a third-party system 350, and/or a data storage 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

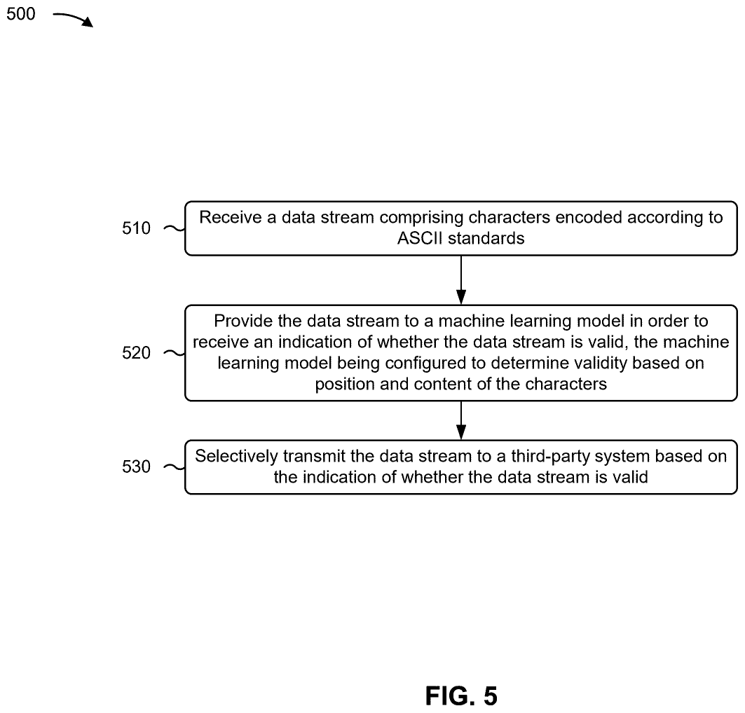

FIG. 5 is a flowchart of an example process 500 associated with using a model to verify quality of a data stream. In some implementations, one or more process blocks of FIG. 5 may be performed by a quality checker 301. In some implementations, one or more process blocks of FIG. 5 may be performed by another device or a group of devices separate from or including the quality checker 301, such as a user device 330, an ML host 340, a third-party system 350, and/or a data storage 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a data stream comprising characters encoded according to ASCII standards (block 510). For example, the quality checker 301 (e.g., using processor 420, memory 430, input component 440, and/or communication component 460) may receive a data stream comprising characters encoded according to ASCII standards, as described above in connection with reference number 115 of FIG. 1A. As an example, the quality checker 301 may receive the data stream from a data storage. For example, the quality checker 301 may transmit a request to the data storage and may receive the data stream in response to the request. Alternatively, the quality checker 301 may receive the data stream from a user device. For example, the quality checker 301 may transmit a prompt to the user device and may receive the data stream in response to the prompt.

As further shown in FIG. 5, process 500 may include providing the data stream to a machine learning model in order to receive an indication of whether the data stream is valid, the machine learning model being configured to determine validity based on position and content of the characters (block 520). For example, the quality checker 301 (e.g., using processor 420, memory 430, and/or communication component 460) may provide the data stream to a machine learning model in order to receive an indication of whether the data stream is valid, the machine learning model being configured to determine validity based on position and content of the characters, as described above in connection with reference numbers 120 and 125 of FIG. 1B. As an example, the quality checker 301 may transmit a request, including the data stream, to an ML host associated with the machine learning model and may receive the indication from the ML host in response to the request. The machine learning model may be trained to determine whether the data stream is valid using position and content of characters in the data stream. For example, the ML model may be a binary classification model. Additionally, or alternatively, the ML model may a cluster model. In some implementations, the ML model may be further trained to determine errors (if any) in the data stream.

As further shown in FIG. 5, process 500 may include selectively transmitting the data stream to a third-party system based on the indication of whether the data stream is valid (block 530). For example, the quality checker 301 (e.g., using processor 420, memory 430, and/or communication component 460) may selectively transmit the data stream to a third-party system based on the indication of whether the data stream is valid, as described above in connection with FIG. 1C. As an example, the quality checker 301 may transmit the data stream to the third-party system based on the indication indicating that the data stream is valid. In another example, the quality checker 301 may refrain from transmitting the data stream to the third-party system based on the indication indicating that the data stream is invalid.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

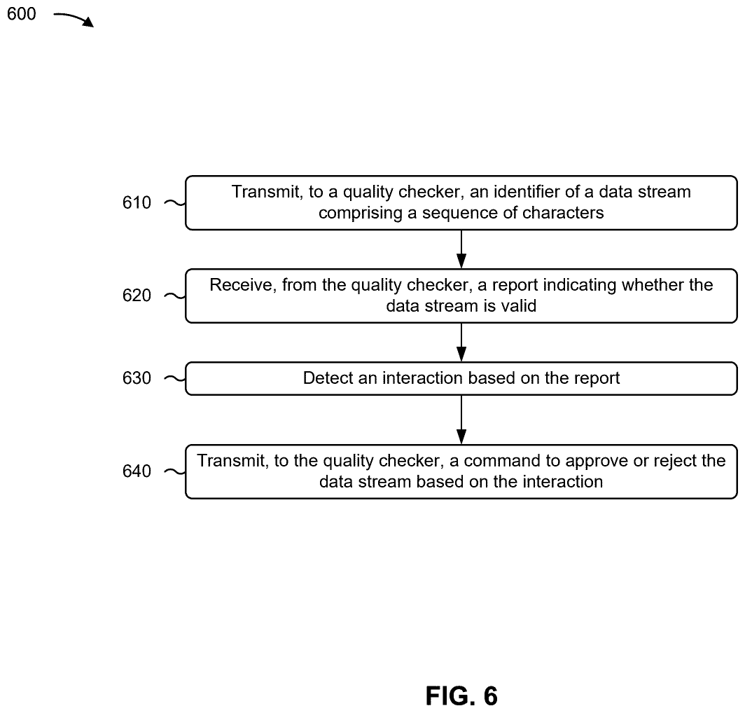

FIG. 6 is a flowchart of an example process 600 associated with instructing a model to verify quality of a data stream. In some implementations, one or more process blocks of FIG. 6 may be performed by a user device 330. In some implementations, one or more process blocks of FIG. 6 may be performed by another device or a group of devices separate from or including the user device 330, such as a quality checker 301, an ML host 340, a third-party system 350, and/or a data storage 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a quality checker, an identifier of a data stream comprising a sequence of characters (block 610). For example, the user device 330 (e.g., using processor 420, memory 430, and/or communication component 460) may transmit, to a quality checker, an identifier of a data stream comprising a sequence of characters, as described above in connection with reference number 105 of FIG. 1A. As an example, the identifier may include a name of the data stream and/or a filepath associated with the data stream, among other examples. The user device 330 may transmit the identifier of the data stream with a request to assess the data stream. For example, the identifier may be included in a header of the request and/or as an argument of the request.

As further shown in FIG. 6, process 600 may include receiving, from the quality checker, a report indicating whether the data stream is valid (block 620). For example, the user device 330 (e.g., using processor 420, memory 430, and/or communication component 460) may receive, from the quality checker, a report indicating whether the data stream is valid, as described above in connection with reference number 130 of FIG. 1C. As an example, the report may be a file, such as a pdf file, among other examples. Additionally, or alternatively, the report may be included in a UI that is output by the user device 330 (e.g., via output component 450 of the user device 330). Accordingly, the user device 330 may receive instructions for the UI.

As further shown in FIG. 6, process 600 may include detecting an interaction based on the report (block 630). For example, the user device 330 (e.g., using processor 420, memory 430, and/or input component 440) may detect an interaction based on the report, as described above in connection with FIG. 1C. As an example, a user of the user device 330 may interact with the report via input component 440 of the user device 330. Accordingly, the interaction may a click of a mouse, a key press on a keyboard, a tap on a touchscreen, or a voice command provided to a microphone, among other examples.

As further shown in FIG. 6, process 600 may include transmitting, to the quality checker, a command to approve or reject the data stream based on the interaction (block 640). For example, the user device 330 (e.g., using processor 420, memory 430, and/or communication component 460) may transmit, to the quality checker, a command to approve or reject the data stream based on the interaction, as described above in connection with FIG. 1C. As an example, the user of the user device 330, after reviewing the report, may interact with a button (or another UI element) associated with approval of the data stream or may provide a text command associated with approval of the data stream. Therefore, the user device 330 may transmit a command to approve the data stream in response to the interaction. In another example, the user of the user device 330, after reviewing the report, may interact with a button (or another UI element) associated with rejection of the data stream or may provide a text command associated with rejection of the data stream. Therefore, the user device 330 may transmit a command to reject the data stream in response to the interaction.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E and/or FIGS. 2A-2B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for verifying quality of a data stream, the system comprising:
one or more memories; and
one or more processors, communicatively coupled to the one or more memories, configured to:
receive the data stream, wherein the data stream comprises characters encoded according to American Standard Code for Information Interchange (ASCII) standards;
provide the data stream to a machine learning model in order to receive an indication of whether the data stream is valid, wherein the machine learning model is configured to determine validity based on position and content of the characters; and
selectively transmit the data stream to a third-party system based on the indication of whether the data stream is valid.

2. The system of claim 1, wherein the one or more processors are further configured to:
transmit a report, to a user device, including the indication of whether the data stream is valid.

3. The system of claim 1, wherein the one or more processors, to provide the data stream to the machine learning model, are configured to:
transmit a request including the data stream to a machine learning host associated with the machine learning model; and
receive the indication of whether the data stream is valid from the machine learning host in response to the request.

4. The system of claim 1, wherein the one or more processors, to selectively transmit the data stream, are configured to:
transmit the data stream to the third-party system based on the indication indicating that the data stream is valid.

5. The system of claim 1, wherein the one or more processors, to selectively transmit the data stream, are configured to:
refrain from transmitting the data stream to the third-party system based on the indication indicating that the data stream is invalid.

6. The system of claim 1, wherein the one or more processors are further configured to:
receive an indication of a location associated with the data stream; and
transmit a request for the data stream based on the location,
wherein the data stream is received in response to the request.

7. The system of claim 1, wherein the third-party system is associated with a credit bureau, and the data stream comprises an update intended for the credit bureau.

8. A method of verifying quality of a data stream, comprising:
transmitting, to a quality checker and from a user device, an identifier of the data stream, the data stream comprising a sequence of characters;
receiving, from the quality checker and at the user device, a report indicating whether the data stream is valid;
detecting, by the user device, an interaction based on the report; and
transmitting, to the quality checker and from the user device, a command to approve or reject the data stream based on the interaction.

9. The method of claim 8, further comprising:
generating an updated data stream based on the report;
transmitting, to the quality checker and from the user device, a request to assess the updated data stream;
receiving, from the quality checker and at the user device, a report indicating whether the updated data stream is valid; and
transmitting, to the quality checker and from the user device, a command to approve or reject the updated data stream based on the report.

10. The method of claim 8, wherein the interaction comprises a click of a mouse, a key press on a keyboard, or a tap on a touchscreen.

11. The method of claim 8, wherein the report further indicates at least one error in the data stream.

12. The method of claim 8, wherein the identifier of the data stream comprises a filepath associated with the data stream.

13. The method of claim 8, wherein transmitting the identifier of the data stream comprises:
transmitting a name of the data stream with the sequence of characters of the data stream.

14. A non-transitory computer-readable medium storing a set of instructions for verifying quality of a data stream, the set of instructions comprising:
one or more instructions that, when executed by one or more processors of a device, cause the device to:
receive the data stream, wherein the data stream comprises a sequence of characters;
provide the data stream to a machine learning model in order to receive an indication of at least one error in the data stream, wherein the machine learning model is configured to determine validity based on position and content of the characters;
transmit a report, to a user device, including the indication of the at least one error;
receive an updated data stream in response to the report; and
transmit the updated data stream to a third-party system.

15. The non-transitory computer-readable medium of claim 14, wherein the one or more instructions, when executed by the one or more processors, further cause the device to:
transmit, to the user device, a confirmation that the updated data stream was transmitted to the third-party system.

16. The non-transitory computer-readable medium of claim 14, wherein the one or more instructions, that cause the device to receive the data stream, cause the device to:
receive the data stream from the user device.

17. The non-transitory computer-readable medium of claim 14, wherein the one or more instructions, that cause the device to receive the updated data stream, cause the device to:
receive the updated data stream from the user device.

18. The non-transitory computer-readable medium of claim 14, wherein the one or more instructions, when executed by the one or more processors, further cause the device to:
receive, from the user device, an indication of a location associated with the updated data stream; and
transmit a request for the updated data stream based on the location,
wherein the updated data stream is received in response to the request.

19. The non-transitory computer-readable medium of claim 14, wherein the data stream comprises a sequence of hexadecimals encoding the sequence of characters according to American Standard Code for Information Interchange (ASCII) standards.

20. The non-transitory computer-readable medium of claim 14, wherein the third-party system is associated with a credit bureau, and the data stream comprises an update intended for the credit bureau.
